(19) United States
(12) Patent Application Publication
(10) Pub. No.: US 2009/0144740 A1
(43) Pub. Date: Jun. 4, 2009

(54) Application-based enhancement to inter-user priority services for public safety market

(75) Inventor: Mingshen Gao, Batavia, IL (US)

Correspondence Address: FAY SHARPE/LUCENT, 1228 Euclid Avenue, 5th Floor, The Halle Building, Cleveland, OH, 44115-1843, US

(73) Assignee: Lucent Technologies Inc.

(21) Appl. No.: 11/998,558

(22) Filed: Nov. 30, 2007

(51) Int. Cl. G06F 9/46

(52) U.S. Cl. 718/103

(57) ABSTRACT

A system and method for application based enhancement to the traditional per-user based inter-user priority services is provided. This method includes provisioning a user's profile, not only with an assigned inter-user priority, but also with zero, one or more specified and provisioned applications that are considered as critical applications which require special preferential treatment by the access network. The method continues with accessing the inter-user priority profile associated for sessions established for the user. The system then recognizes that a session may have been assigned to at least one provisioned critical application. The system may then provide inter-user priority services operative to provide the specified preferential treatment for at least the critical applications associated with the session when the critical application(s) are activated. In this form, the critical applications are better served including protection again congestion and availability of resources whenever they are needed. This system may grant preferential treatment on a session and/or application basis so that there will be no impact on other general applications when no critical applications are activated. This is especially useful for public safety implementation where protecting the mission-critical communication is a fundamental requirement.

### BACKGROUND OF THE DISCLOSURE

This disclosure relates to application based enhancement in order to offer inter-user priority services for provisioned applications. More particularly, this disclosure relates to a method and apparatus that allows for the recognition of a provisioned critical application and provides specified preferential treatment to the provisional critical application when it is activated. This method and apparatus will be particularly useful in the public safety market.

While this disclosure is particularly directed to telecommunication provisioning with dynamic adjusting of inter-user priority service related parameters for providing better support for provisioned critical applications while, at the same time, preserving full capacity/effectiveness of the standard/traditional static or fixed per-user provisioned inter-user priority service in the public safety market and will thus be described with particular reference thereto, it will be appreciated that the disclosure may have usefulness in other fields and applications. For example, this disclosure may be useful in a variety of services where bandwidth may be limited and priority based preference should be given to critical, or otherwise favored, applications.

By way of background, the third generation wireless network can generally support only a limited number of simultaneous high speed/high bandwidth applications. For example, each carrier in Code Division Multiple Access/EVolution Data Optimized (CDMA/EV-DO) can support approximately three to five very high resolution simultaneous video streams in the reverse link and about five to seven in the forward link with good quality. If more high resolution videos are activated at the same time, then degradation in video quality is likely to occur. Therefore, when many users are making high speed data transfers at the same time, these users will feel the impact of each of the other users. Similarly, or more realistically, if there are enough active users (users who are in the connected state) to consume more than the system's capable bandwidth, every user will be impacted by each other's presence, since they are all sharing the same limited air interface bandwidth. This may be the case even when their applications are not of the type that demand high-bandwidth. Because of this limitation, it is necessary to protect the critical applications for any CDMA/EV-DO public safety deployment by giving them their required bandwidth when they need it. There are few viable solutions geared towards reserving room for the high speed/high bandwidth critical applications.

Currently in the industry, there are no known solutions to overcome this problem. However, there are few partial solutions that may be used to partially overcome some of the aforementioned difficulties. One of them is to separate the application based on its service category. This CDMA standard solution specifies an intra-user Quality of Service (QoS) mechanism based on the division of service categories for reflecting application's QoS requirements. The basic QoS service categories are voice, video (these are the low data rate conversational videos for Video-Telephony service, rather than the high resolution streaming videos) and their associated signaling. Almost all other applications are covered by a Best Effort (BE) service category. This design allows for preferred treatment in transferring different flows of data packets for applications in different service category for the same user. But it cannot differentiate applications in the same category. For example, if a user has a voice application, the flow of voice packets will be transmitted ahead of the flow of data packets. This feature could enable the preferential treatment for all flows of voice packets over all flows of data packets. However, it cannot be used for preferential treatment to flows of data packets that are in the same service category whether or not the flows are belonging to the same user or not. Such, it cannot be used for inter-user data flows that belong to the same service category, even though almost all the applications are categorized as the best effort applications. Furthermore, there are only a few clearly defined service categories and the service categories are purely for the purposes of QoS management in order to satisfy QoS characteristics, such as delay sensitivity requirements. In turn, there exist applications that have high bandwidth requirement, but are not highly delay sensitive (e.g. high resolution streaming videos). Such applications would be fit into the best effort service category, although many of them are considered as the critical applications, especially in the public safety market. These critical applications would not receive preferential treatment over other applications that are similarly situated and they may fail to get the necessary bandwidth when the system is somewhat congested.

Another proposed solution in the industry includes defining an inter-user priority based on provisioning of classified users. This solution is also flawed in the sense that it is not application based. In this traditional or standard per-user based inter-user priority service, all applications (critical or otherwise) from the same user/device will be treated in the same way. A user with an active critical application could be impacted by general applications from other users that have assigned higher or even equal to slightly smaller (when there are many of them) priorities. Therefore, this solution cannot gauge whether critical applications are activated or which applications should have been given the necessary special preferential treatment, even though this is a fundamental requirement for the public safety market.

Therefore, there is a need in the industry to design a system that provides better preferential treatment to certain critical applications while still preserving the effectiveness and the capacity of the per-user based inter-user priority service. Furthermore, there is a need in the industry to utilize application-based dynamic adjustable features for enhancing the inter-user priority service.

Furthermore, it would be useful for the system to adjust the inter-user priority service related attributes at the presence of critical applications, creating a temporary, “effective” inter-user priority for each active user. This would allow for better service to the critical applications with the necessary special preferential treatment, while still allowing normal users to maintain their original assigned inter-user priority. In which case, the original assigned inter-user priority may be restored once the critical application has become deactivated.

The present disclosure contemplates a new and improved system and method that resolves the above-referenced difficulties and others.

### SUMMARY OF THE DISCLOSURE

A method and apparatus for recognizing critical applications and providing enhanced inter-user priority services based on the application activation and presence is provided. This disclosure will allow for dynamic adjusting of inter-user priority service related parameters used by the system for providing inter-user priority services to all priority levels to serve critical applications with better preferential treatment as they are required or specified, including protection for critical applications during high traffic situations. This ability of adjusting parameters that define the service in the activation/presence of critical application will not only provide better service to the provisioned critical applications but also allow for maximum capacity/effectiveness of the original per-user based inter-user priority services in the absence of activated critical applications. This disclosure solves the problems in achieving the two conflicting goals for implementing inter-user priority services and its benefits are essential for satisfying the fundamental requirement of the public safety market.

In one aspect of the disclosure, a method for differentiating critical applications from non-critical general applications in order to provide better services to the critical applications comprising provisioning the inter-user priority profile (which could be part of a wildly used, standard-defined general per-user/per-subscriber profile) for an user or a device with zero or more specified (provisioned) applications, accessing the inter-user priority profile associated for a session established for the user/device, recognizing that the session has been assigned with at least one critical application through the inter-user priority profile and providing inter-user priority services operative to provide the preferential treatment specified by separately provisioned inter-user priority service related parameters for at least the critical applications associated with the session.

In accordance with another aspect of the present disclosure, the method includes ways for providing inter-user priority services that includes at least in part adjusting parameters configured to provide differentiated preferential treatment for the critical applications.

In another aspect of the present disclosure, the method further includes adjusting the forward link scheduler priority weight that controls the short term (millisecond-level) data rate for at least the critical applications associated with the sessions.

In accordance with another aspect of the present disclosure, the method includes adjusting the forward link bandwidth cap that limits the maximum long term data rate for at least the critical applications associated with the sessions.

In accordance with another aspect of the present disclosure, the method includes adjusting a reverse traffic channel medium access control (RTCMAC) attribute that is configured to control reverse link short term (millisecond-level) data rate based on current system RL loading.

In accordance with another aspect of the present disclosure, the method includes adjusting the RTCMAC attribute for controlling the reverse link maximum data rate in order to limit the long term data rate to within the specified range.

In accordance with another aspect of the present disclosure, the method includes temporarily shifting the relative weight for all other non-critical general applications in a forward link scheduler for giving better bandwidth protection (short-term data rate) to critical applications.

In accordance with another aspect of the present disclosure, the method includes dynamically adjusting inter-user priority service related parameters for all other active sessions that are sharing the same resources with the critical applications.

In accordance with another aspect of the present disclosure, the method includes signaling the activation and deactivation of critical applications.

In accordance with a system that allows for application based enhancements to inter-user priority services, the apparatus includes an Authorization, Authentication Accounting (AAA) network element configured to provision for an inter-user priority attribute and attributes to identify a device or an user as having a list of provisioned critical applications from an inter-user priority profile and a Radio Access Network (RAN) configured to provide inter-user preferential treatment to the identified critical applications.

In accordance with another aspect of the present disclosure, the system includes a packet data serving node configured to pass the inter-user priority profile associated with a user or a device to the session established for the user/device in the radio access network.

In accordance with another aspect of the present disclosure, the system includes that preferential treatment includes dynamically adjusting a radio network controller provisional parameters for providing inter-user services.

In accordance with another aspect of the present disclosure, the system includes that preferential treatment includes adjusting an admission control function to allow the connection of the access terminal for the session that has the critical applications even when the system is congested.

In accordance with another aspect of the present disclosure, the system includes an access terminal that is configured to signal the activation status of the critical application for triggering the provisioned inter-user preferential treatment.

According to another aspect of the present disclosure, the system includes adjusting the inter-user priority service parameters assigned to all other active sessions and/or all other sessions that are to be activated (in the middle of setting up connection) where at least one of the active sessions are having active critical applications.

According to another aspect of the present disclosure, the system includes that preferential treatment can also be provided on a per active-session (the session is in the connected state) basis if the access terminal is incapable of signaling the activation of provisioned critical applications.

According to another aspect of the present disclosure, the system includes that preferential treatment is provided on a per application basis if the access terminal is capable of signaling the activation of critical applications.

### DESCRIPTION OF THE DRAWINGS

The presently described embodiments exist in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the overall communications network including two access terminals, one of which including a critical application, an access network including a base station and radio network controller, a Packet Data Serving Node (PDSN) an Authorization Authentication and Accounting (AAA) network element, and an Internet Protocol (IP) network.

FIG. 2 illustrates a more detailed portion of the overall communication network of FIG. 1.

FIG. 3 is a flow chart illustrating one embodiment of the method according to the present disclosure.

### DETAILED DESCRIPTION

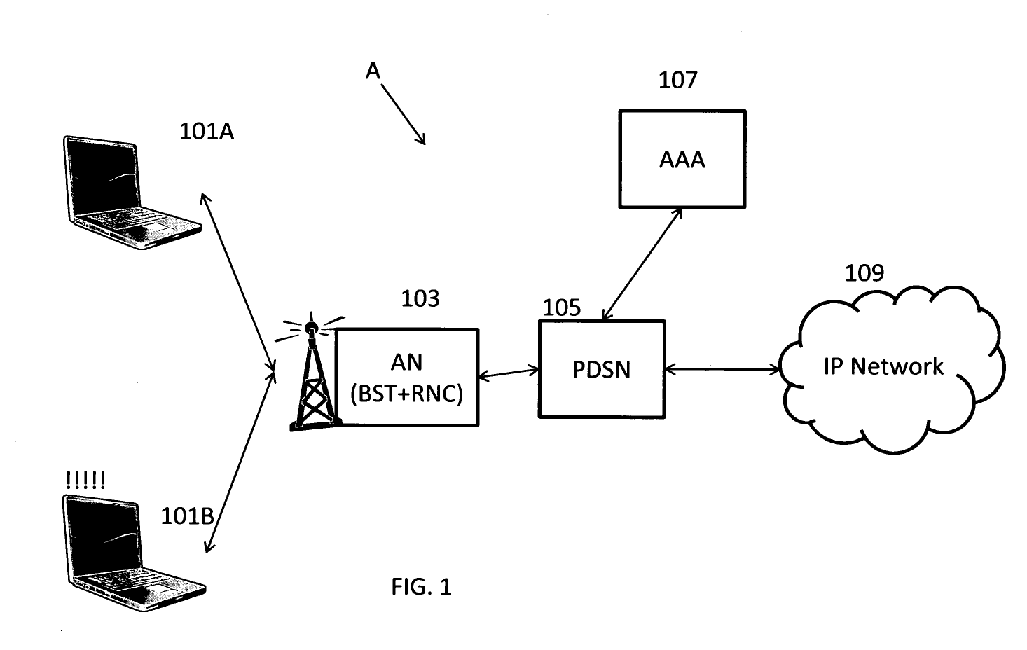

Referring now to the drawings wherein the showings are for purposes of illustrating the disclosed embodiments only and not for purposes of limiting the claimed subject matter, FIG. 1 provides an overall view of the system into which the present disclosure may be incorporated. A communications infrastructure A is shown. The communications infrastructure A includes a first and second access terminal 101A, 101B, where the second access terminal 101B includes a critical application. The communications infrastructure also includes an access network including a basestation and a Radio Network Controller (RNC). Also included in the communications infrastructure A are a PDSN 105, an AAA 107 and an IP network cloud 109. It should be understood that this represents but one embodiment of the communications network infrastructure. The present disclosure could be incorporated in a variety of communication network configurations.

In operation, as described in greater detail below, the presently described embodiments are directed towards a method for allowing application based enhancements to enter user priority services. The system and method will allow for the achievement of two goals which appear to be somewhat conflicting. These two goals are 1) preserving the effectiveness and capacity of the inter-user priority service and 2) providing better preferential treatment to critical applications. This system will allow for the protection of critical applications in a highly congested system which is very desirable when public safety comes at issue. Through this disclosure, a system will be able to run at capacity without having to pre-allocate resources for critical applications that may or may not be activated. However, when critical applications attempt to enter the system, resources will be re-arranged in order to increase the likelihood (and if desired, guarantee) that the critical applications will be allowed to access the network. In this form, resources will not be wasted in the anticipation of a critical application while at the same time critical applications will instantly gain access to busy networks through a prioritized status which may be dynamically implemented.

Still referring to FIG. 1, the system has sessions for a plurality of access terminals 101A and 101B and when a session is in active state, a connection over the air interface will also be established. In this embodiment, the access terminal 101B has a critical application associated with it. The access terminals in this embodiment are shown as laptop computers. These access terminals are in communication (e.g., the access terminals have active sessions with connections) with an access network 103. The access network 103 is a combination of a base station and an RNC. The access network 103 is connected with the PDSN 105. The PDSN 105 is in turn connected with an MA 107 and the IP network 109. Again, this is but one embodiment of the communication network and a variety of other networks may be used in order to implement this disclosure.

Continuing on with FIG. 1, this embodiment shows a laptop as the access terminal 101A, 101B. However, other equipment besides laptops may be used in order to access the network. For example, an access terminal may be in the form of a desktop computer, a PDA device, a video capturing device, a land line telephone, a Voice over Internet Protocol (VoIP) telephone, etc. may be substituted. These devices, alone, or in conjunction may be used in order to connect to the access network 103. In this embodiment, the second access terminal 101B is connecting for a session containing a critical application. For example, this could be a very high-resolution video surveillance device which could be triggered by certain types of activities and the video stream sent by the device could be very important to be qualified as critical applications in public safety sector. An inter-user priority profile which contains the identification for specifying the critical application associated with the session reflects this scenario.

The access network 103 generally includes a basestation, a radio network controller and a scheduler that is often located at the basestation for controlling the actual data transmission over the air interface for all applications running by all active sessions (users). It should be appreciated that the access network 103 may also be known as a Radio Access Network (RAN). Furthermore, although in this embodiment the access network is grouped with a base station and an RNC, this need not be the case in every embodiment.

The access network 103 is generally used to provide inter-user priority service based preferential treatment to critical applications. In this embodiment, the second access terminal 101B is connected for a session that contains a critical application. The access network 103 may provide preferential treatment to access terminal 101B in many ways, some of which are detailed below.

The access network 103 is in communication with the PDSN 105. The PDSN 105 is the connecting point between the access network 103 and an IP network 109, as this is the standard configuration defined for CDMA/EV-DO based RAN. The PDSN 105 is generally responsible for managing the Point to Point Protocol (PPP) sessions to the access terminal 101A, 101B for passing data between the IP network 109 and the access terminals. The PDSN 105 is also responsible for passing the inter-user priority profile which, in this specific embodiment, is just part of the Subscriber QoS Profile through an A11 session update message and/or an A11 registration reply message. The message is sent to the RNC that has established sessions for the users. A user with a session will not necessarily have a connection over the air interface if it is not in active state, but the user's session will generally stay in the circumstances. A user's Subscriber QoS Profile is typically sent to the user's session when the session is first established (the first real connection after the session negotiation) by the RNC.

The AAA 107 is another network component that is in communication with the PDSN 105. A FlowProfileID, which is used in this embodiment for representing a provisioned critical application, is added to the subscriber QoS profile in the AAA 107. Access terminal 101B is provisioned so that the critical application identified by the FlowProfileID is allowed for the access terminal. This is done during the provisioning when the list of approved FlowProfileIDs for the user is created or modified/updated. Once the AAA 107 adds the FlowProfileID to the subscriber's QoS profile, a user or a device (in this embodiment, the access terminal 101B) is permitted to run a critical application. This information is passed to the RNC located in the access network 103 via an A11 session update or an A11 registration reply message from the PDSN 105 when the PPP is established for the session. The RNC will save this information to the session's record. The RNC will also provide the specified inter-user priority service based preferential treatment to the session when the application is activated.

Each critical application will be identified by a unique FlowProfileID. The FlowProfileID concept has been defined for CDMA/EV-DO networks for identifying the service needs and for facilitating proper processing within the access network and the access terminals 101A, 101B for an application flow. For this embodiment, either a standard FlowProfileID or a proprietary FlowProfileID may be used for identifying/specifying the application (e.g., one of the standard FlowProfileID assigned in the generic data service category, 0x002c, could be used to specify an application flow that requires a minimum acceptable user data rate of 384 kbps, maximum latency of 2 seconds, and so on). The RNC will also have separated provision parameters for each FlowProfileID that is used for identifying a critical application. These parameters for each FlowProfileID are designed to reflect the inter-user priority service based preferential treatment that will be given to the critical application. This may include a parameter that signals whether the critical application should be absolutely admitted for bypassing the admission control, a parameter that indicates its impacts on other users such as whether the scheduler weight should be adjusted for all other active sessions, etc. Preferential treatment specific to the critical application may also include parameters such as ones for controlling the reverse link and forward link bandwidth caps, forward link scheduler weight and/or reverse link congestion related short term data rate.

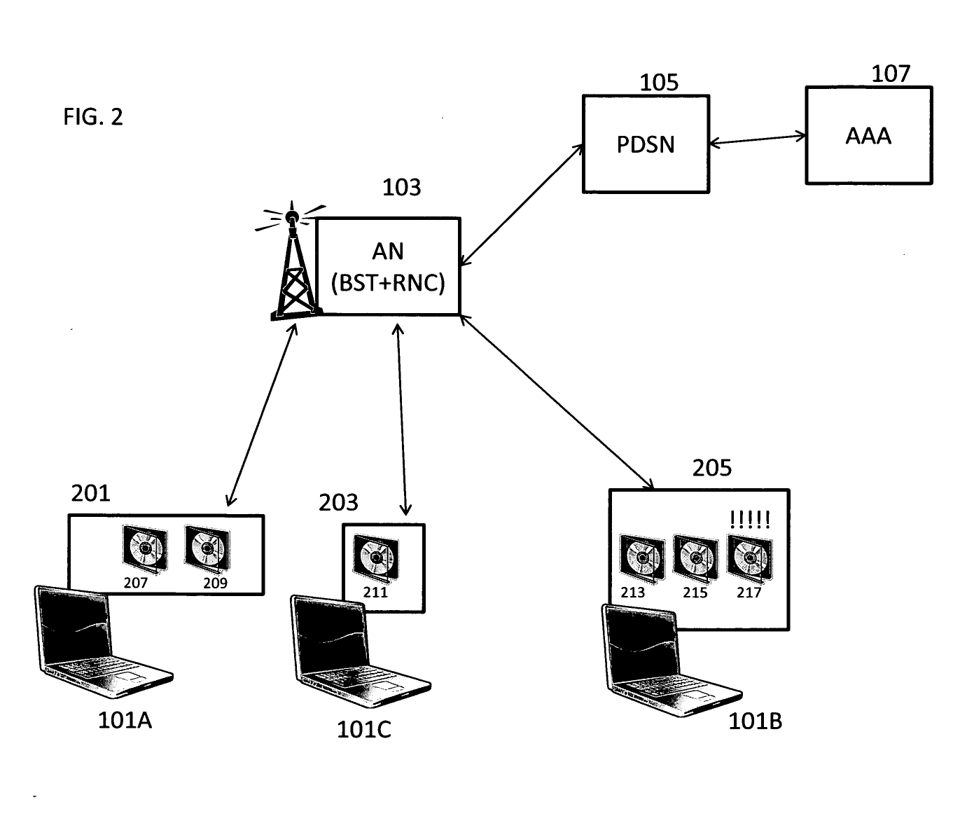

Now referring to FIG. 2, a more detailed portion of the overall communication network disclosed through FIG. 1 is illustrated. This figure also shows an additional access terminal 101C and the sessions 201, 203 and 205 associated with each access terminal 101A, 101C and 101B, respectively. Access terminal 101A has associated with it two applications, 207 and 209, neither of which are critical. Access terminal 101B is associated with session 205 and has two non-critical applications 213 and 215 and one critical application 217. Access terminal 101C is associated with session 203 which has one non-critical application 211. This is but one embodiment of a sample communication network. Once again, it should be appreciated that other communication's networks could be shown as well as other communication network elements including, but not limited to switches, gateways, IP networks, etc.

Each of the three access terminals are attempting to gain access to a bandwidth limited access network 103. Without the enhancement in this disclosure, if the three access terminals have equal priorities and the combined bandwidth requirement is higher than the system's bandwidth capacity, they will have to compete for the limited resources. Under these circumstances every one them will suffer to some extent. In a real world scenario, this kind of congestion in wireless access network can be easily caused by bursts of many (more than three shown in FIG. 2) active sessions' transferring data due to the bandwidth limitation.

As the situation is shown here, session 205 has one critical application 217. This disclosure will allow for the critical application 217 to gain preferential treatment for getting its needed bandwidth with respect to the non-critical applications. This preferential treatment may be given on an application basis and/or a session basis.

In this embodiment, access terminal 101B is configured to signal the activation status of a critical application 217 via the ReservationOnRequest signaling message defined in the CDMA/EV-DO standard. The RNC will then mark the session with activated critical applications and provide the session with the specified inter-user priority service based preferential treatment, even though only the best effort flow may be used for carrying the critical application's data with the access network. In this form, while 217 is engaged, access terminal 101B receives preferential treatment over the access terminals 101A, 101C. However, once the activation status of the critical application 217 is turned off, 101B will no longer receive preferential treatment. Also in this form, it will not be required that the user and/or access terminal 101B have an ordinary priority status that is favored over the other users and/or access terminals 101A, 101C. Furthermore, the assigned/provisioned priority for access terminal 101B may be even lower than the assigned/provisioned priorities for access terminals 101A and 101C.

Some of the simpler or old devices (e.g., a simple video capture device) may not support the Multi-Flow Packet Application (MFPA) capability defined in RevA for CDMA/EV-DO. Many of the older devices are incapable of signaling the activation of a critical application. To support these devices in this embodiment, once the provisioned FlowProfileID the AAA 107 is sent to the session 205, the system will recognize that this session has been assigned with a critical application 217. This will signal to the access network 103 that preferential treatment should be given to session 205 when connection is requested for the session. In this case, the bandwidth given to the session may be limited so that it is just enough for the critical application for preventing abuse by other applications even if the device is even capable of running them by chance.

Preferential treatment may be applied in a manner of ways. In one embodiment, preferential treatment includes adjusting the forward link scheduler priority weight for the critical applications. For example, if access terminal 101B is generally supposed to receive a weight of 4, on a scale of 1-7, the weight may be adjusted to a 7, in order to provide the critical applications with its required data rate.

In another embodiment, the enhanced inter-user priority service includes adjusting the forward link bandwidth cap for the critical applications. For example, the access network 103 may change the bandwidth cap to limit the maximum data rate (note, this is the long term data rate rather than the short term data rate that is measure in millisecond-level duration). This kind of bandwidth management will allow the system to give enough bandwidth to the critical application 217 and/or session 205, and at the same time, its impact to all other users will be effectively limited.

In still another embodiment, the enhanced inter-user priority service may include adjusting the RTCMAC attributes. The RTCMAC attribute T2PTransmissionFunctionNN is used in CDMA/EV-DO for controlling the reverse link transmission power, therefore the short term data rate that are measured in millisecond-level duration, based on the system loading. This would essentially increase the priority status of the critical applications to allow them to transmit their data at a much higher short term data rate as compared with other users. Similarly, another RTCMAC attribute T2PInFlowRangeNN is used in CDMA/EV-DO for controlling the reverse link bandwidth limit that is configured to control reverse link maximum data rate. This adjustment would be operative to limit the reverse link bandwidth usage.

In other circumstances, there may be a need to adjust the relative weight of other applications served by the same cell that is also serving an activated critical application. For example, if access terminal 101A was already at a maximum priority level, e.g., on a scale from 1-7, the weight for the access terminal 101A for session 201 is of priority 7 level, then the relative weight may need adjusting. In this form, the access network 103 may adjust all other relative weights to be a lower number so that session 205 with the critical application 217 may access the network through access terminal 101B at a weight of priority level 7. In this form, all other applications would have a relative weight of priority level 6 or lower, giving access terminal 101B the highest priority level weight. With this feature, the other users' “effective” inter-user priority could be adjusted based on the presence of an active critical application at each specific cell. This will allow for a situation where only active users served by the cell that is serving critical applications to be impacted. The majority of the users in the system will not be impacted. The weight change will effectively lower the priority even though the actual provisioned priority has not been changed. The session would appear to have a lower ‘effective’ inter-user priority.

In other embodiments, the actual user priority provisioned may not need to be adjusted, but the parameters for controller bandwidth caps and the parameters for controlling data rates for both the reverse link and the forward link could be adjusted. For example, the weight used for the forward link scheduler at a cell for all other active sessions (or at least for the ones that have a relative higher weight) can be shifted down by one or more levels automatically by the scheduler on the presence of a critical application. This can be done dynamically when critical application is activated at a cell. There is no need to change the actual parameters given to the impacted sessions based their original assigned/provisioned priority. In this form, the system will have a greater flexibility for adjusting parameters individually without resetting or limiting parameters provisioned for each inter-user priority. The impact to all non-critical active sessions served by a cell that is also serving critical applications is done automatically while all other active sessions served by other cells in the AN will not be impacted at all.

In another embodiment, the enhanced inter-user priority services includes varying the admission control parameters for critical applications. In this form, the proposed inter-user priority service will have the ability of modifying the wireless access network's admission control function for critical applications. The accessing network's admission control function will allow the connecting of an accessing terminal 101B for an emergency, even when the network is congested. In this form, generally, the emergency will involve a critical application as defined by the system. This priority will either increase the probability of a connection during network congestion or even mark specific applications to be admitted under any loading condition for guaranteeing access by critical applications.

Any of these inter-user priority services may be implemented even if other critical applications are attempting to access the network at the same time. For example, still referring to FIG. 2, in some embodiments application 211 may also be a critical application. In this form, this disclosure will allow for the adjustment of other critical applications or applications that are not critical, depending on the implementation of the apparatus and methods described in this system.

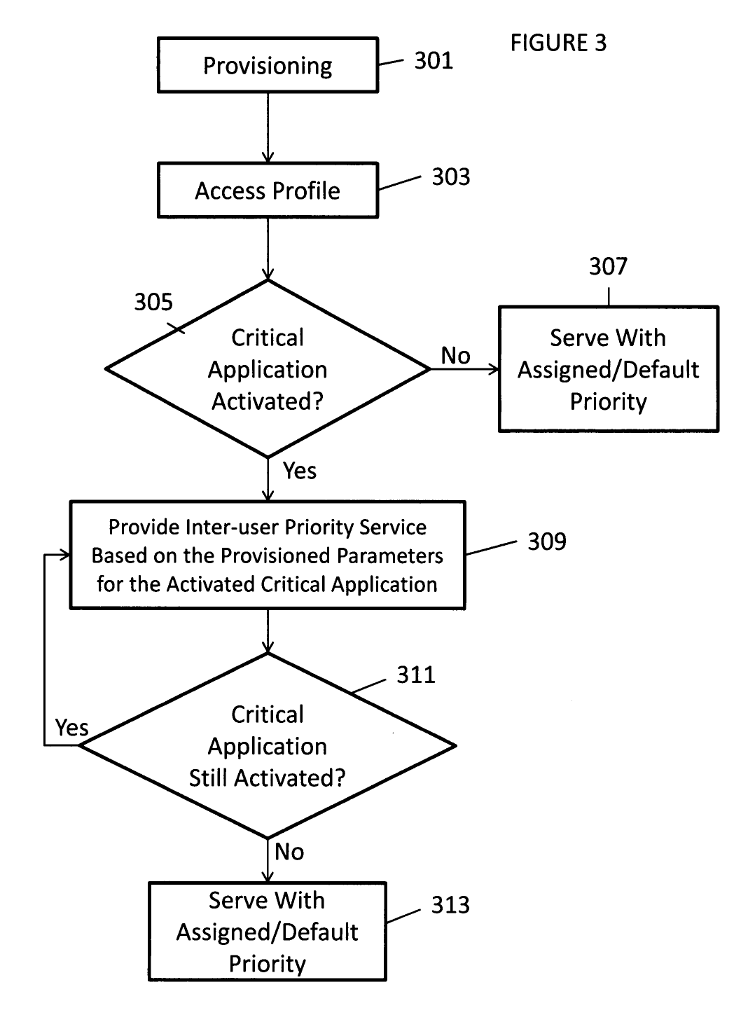

Now referring to FIG. 3, a flow chart illustrating one of the embodiments of the method according to the present disclosure is shown. This figure generally shows the step included in the services related to an application based inter-user priority service.

Still referring to FIG. 3, the method begins with provisioning a session (at step 301). During this step, provisioned applications (also referred as critical applications in this disclosure) are assigned to an access terminal 101B for all its established sessions. In this embodiment, the session 205, FIG. 1, includes a critical application 217.

Continuing on with FIG. 3, the method continues with accessing an inter-user priority profile (at step 303). Generally, this profile will be just a subset of a per-user profile maintained by the access network or service provider's core network, like the AAA 107 in FIGS. 1 and 2. This inter-user priority profile may include identification for each one of provisioned critical applications that is assigned to or approved for the user/device. Through this disclosure critical applications will receive the specified priority services which will allow a session with activated critical application to gain access to the services in a more efficient manner. These inter-user priority services based preferential treatment was explained in detail above.

The system (at step 305) determines if the session has a critical application activated. If it has no critical application being provisioned to the session, or none of the provisioned critical applications are activated, the session may resume with its current/default priority status (at step 307). In this form, no application based inter-user priority services are issued to the session. The session would receive the default inter-user priority service based on its assigned/provisioned priority.

The method continues with providing priority status if the session does have a critical application activated (at step 309). The inter-user priority services provided through this disclosure may vary. For example, in one embodiment, the priority service includes adjusting the forward link scheduler priority weight. In another embodiment, the forward link bandwidth cap is adjusted for critical applications. In yet another embodiment, the reverse traffic channel medium access control attribute that controls reverse link short term data rate is adjusted. In yet another embodiment, the RTCMAC attribute that controls the maximum bandwidth usage or long term data rate is adjusted. In yet another embodiment, priority services include shifting the relative weight of applications in the forward link scheduler. In still another embodiment, the network allows admission control for critical applications.

These priority services (at step 309) may cause the dynamic adjustment of inter-user service related parameters for other non-critical active sessions which are sharing the same needed resources as the activated critical applications. In this form, the network may lower the parameters assigned to these impacted active users, which, in some respect, is equivalent to temporarily giving them a different ‘effective’ inter-user priority. But the effective inter-user priority would be higher for the critical applications. Furthermore, these inter-user priority services related parameters may be effective for already connected sessions and sessions which are in the process of being connected. All these changes can be adjusted dynamically for effective inter-user priority based on the presence of critical applications. The various priority services may also work independently or in tandem with one another.

The method continues with the system determining if the critical application is still activated at step 311. If the critical application is not still activated, the priority services may be disabled (at step 313). Otherwise, the system will generally continue to provide priority services (at step 309) until the critical application has been deactivated.

The above described embodiments that were shown in FIG. 3 present but one embodiment of the above-described disclosure. Implementation of these various network elements and the steps that they perform depend on how the system is used. These functions may be performed by some or all of the various network elements in conjunction or separate from one another and variations may exist. Description of these embodiments is not meant to limit the claims but instead show how some of the embodiments of the methods may be used.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for dividing critical applications from non-critical applications in order to provide priority services to said critical application comprising:
provisioning for an inter-user priority and a list of provisioned critical applications;
accessing an inter-user priority profile associated with the session;
recognizing that said session has been assigned at least one critical application through said inter-user priority profile; and
providing inter-user priority services operative to provide said critical application with specifically designed inter-user priority service based preferential treatment for at least said critical applications associated with said session.

2. The method according to claim 1, wherein providing inter-user priority services includes adjusting the forward link scheduler priority weight that controls the short term data rate for at least said critical applications associated with said sessions.

3. The method according to claim 1, wherein providing inter-user priority services includes adjusting the forward link bandwidth cap that limits the maximum long-term data rate for at least said critical applications associated with said sessions.

4. The method according to claim 1, wherein providing inter-user priority services includes adjusting a reverse traffic channel medium access control attribute that is configured to control reverse link short term data rate based on the current system reverse link loading.

5. The method according to claim 1, wherein providing inter-user priority services includes adjusting a reverse traffic channel medium access control attribute that is configured to control reverse link maximum data rate for limiting the data rate to within the specified range.

6. The method according to claim 1, wherein providing inter-user priority services includes temporarily shifting the relative weight of other or general applications in a forward link scheduler in the presence or activation of critical applications.

7. The method according to claim 1, wherein providing inter-user priority services includes varying the admission control of said critical applications.

8. The method according to claim 1, wherein providing inter-user priority services includes dynamically adjusting inter-user priority service related parameters for other active sessions that are sharing the same resources with said critical applications.

9. The method according to claim 1, further comprising signaling the activation and deactivation of critical application.

10. A system that allows for application-based enhancement to inter-user priority services comprising:
an authorization authentication accounting network element configured to provision for an inter-user priority attribute and attributes to identify a device or an user as having at least one provisioned critical applications from an inter-user priority profile, where the inter-user priority profile is adapted to be part of the standard defined per-subscriber profile;
an radio access network configured to provide inter-user preferential treatment to said provisioned critical applications; and
a packet data serving node configured to pass said inter-user priority profile associated with a session to said radio access network.

11. The system according to claim 10, wherein said preferential treatment includes dynamically adjusting a radio network controller provisional parameters for providing inter-user services.

12. The system according to claim 10, wherein preferential treatment includes adjusting an admission control function to allow the connection of an access terminal for said session that includes said critical application.

13. The system according to claim 10, further comprising an access terminal that is configured to signal the activation status of said critical application which triggers said inter-user preferential treatment.

14. The system according to claim 10, wherein said radio access network is adapted to temporarily shift the weight of other non-critical applications in the forward link of sessions, in the presence or activation of critical applications.

15. A system for providing an application-based inter-user priority service comprising:
an authorization authentication and accounting element adapted to provision for a inter-user priority attribute and attributes to identify a device or an user as having a list of provisioned critical applications from an inter-user priority profile, where the inter-user priority profile can be just part of the standard defined per-subscriber quality of service profile;
an access network including basestations, a radio network controller and a scheduler at each of the sectors at the basestation adapted to provide preferential treatment to said identified critical applications; and
a packet data serving node configured to pass said inter-user priority profile associated with said session to the said radio access network.

16. The system according to claim 15, wherein said preferential treatment is provided on an application basis.

17. The system according to claim 15, wherein said preferential treatment is provided on a session basis.

18. The system according to claim 15, wherein said preferential treatment includes adjusting the weighted preference of other associated sessions.

19. The system according to claim 15, wherein said preferential treatment includes adjusting the forward link scheduler priority weight that controls the short term data rate for at least said critical applications associated with said sessions.

20. The system according to claim 15, wherein said preferential treatment includes adjusting the access terminals' reverse traffic channel medium access control attributes that are configured to control reverse link maximum data rate for limiting the data rate to within the specified range and to control the short data transmission based on system loading condition.
